(19) United States
(12) Patent Application Publication
(10) Pub. No.: US 2009/0083133 A1
(43) Pub. Date: Mar. 26, 2009

(54) Method and system for electronic payment of missed tolls

(75) Inventors: Michael Catolico, Chicago, IL (US); Thomas Morache, Dyer, IN (US); Michael T. Levar, JR., Palatine, IL (US); Wendy Maka, Palos Heights, IL (US)

Correspondence Address: ROCKEY, DEPKE & LYONS, LLC, SEARS TOWER, SUITE 5450, CHICAGO, IL, 60606-6306, US

(73) Assignee: The Illinois State Toll Highway Authority

(21) Appl. No.: 12/283,555

(22) Filed: Sep. 12, 2008

Related U.S. Application Data
(60) Provisional application No. 60/993,733, filed on Sep. 14, 2007.

(51) Int. Cl. G06Q 30/00; G06Q 50/00; G06Q 20/00

(52) U.S. Cl. 705/13; 705/30; 705/34; 705/40

(57) ABSTRACT

A method and system for the electronic payment of unpaid or missed tolls utilizing a web-based system that records information relating to the unpaid or missed tolls and provides access to drivers or customers to a website whereby drivers/customers can electronically arrange for non-cash payment of unpaid or missed tolls. The method and system also allows for the ability to audit various types of information relating to such payments, to remove or delete information relating to violations when payment has been made and to generate various reports for accounting, financial, enforcement and other operational purposes.

### CROSS REFERENCE TO RELATED APPLICATIONS

This application claims priority to U.S. Provisional Patent Application Ser. No. 60/993,733 filed Sep. 14, 2007, the entire disclosure of which is incorporated herein by reference. Priority to this application is claimed under 35 U.S.C. §§ 119 and/or 120.

This invention relates to a system and method for the electronic payment of missed tolls by motor vehicles traveling on highways, expressways, tollways, toll bridges and the like, namely roadways on which fees are charged for travel along them.

### BACKGROUND OF THE INVENTION

As is well known throughout this country, various states and local municipalities have avenues of travel, that is, highways, expressways, tollways, bridges and the like on which fees or tolls are charged to motor vehicles for use of such roadways. Such fees can be flat rates or based on distance traveled. Over the last several years, methods, systems and equipment for electronic monitoring of such travel and collection of such fees have been developed and placed in use. Such methods, systems and equipment are disclosed, for example, in U.S. Pat. Nos. 6,661,352 and 6,653,946.

Such systems, known in the State of Illinois as I-PASS and in certain regions as EZ-PASS, typically employ transponders or tags for motor vehicles that can be detected by, and establish some type of communication with, stationary readers typically positioned at toll plazas or on structures that span the lanes of a highway or tollway. The transponders or tags are registered with the various regional tollway or roadway authorities and typically contain electronic data identifying the owner of the transponder as well as providing a monetary balance for payment of fees for the tolls.

Typically, when vehicles having active transponders or tags pass through a toll plaza, or pass by or under a structure on which readers are positioned, the readers recognize or communicate with the transponders and electronically deduct the amount of the fee or toll from the balance on the transponders or tags. The ability to provide for the immediate electronic payment of tolls and fees while vehicles are moving down the highway or roadway has led to the development of “Open Road Tolling”, allowing a freer flow of traffic and reducing congestion at toll booths and plazas.

While open road tolling has provided benefits to the flow of traffic across our highways, it has also resulted in certain problems in collecting fees or tolls. One problem that has always existed has been caused by vehicles which pass through non-gated lanes in the traditional toll plaza without paying any toll or fee. That problem still exists and has been exacerbated by open road tolling systems—now vehicles that do not have active transponders positioned in them are able to go through the open lanes in the open road tolling systems without paying tolls at all. Thus, the incidents of non-payment or missed tolls have dramatically increased.

Most, if not all, of such open road tolling systems have some type of surveillance systems in place to identify vehicles and drivers that miss or fail to pay tolls. Usually such systems include cameras and/or electronic devices which capture pictures or images of the vehicle, its license plates, or both and transmit that information to an enforcement authority, department or division. The typical enforcement procedures include sending out, usually by mail, notices of non-payment or missed tolls, the amounts due for the tolls and a penalty for failure to pay tolls. Such procedures often can be and are costly, requiring not only extensive paper work but also the necessary personnel to generate, collect, deposit and monitor the collection and enforcement processes.

State and local governmental agencies likewise recognize that while non-payment of tolls may be intentional, most times missed tolls are accidental. Thus, there are many occasions on which drivers recognize that a toll has not been paid or is missed and such drivers wish to rectify the situation on their own. Until recently, the process for doing so has required identifying the correct authority or agency, contacting by telephone or in writing that authority and then engaging in the necessary paperwork to make payments, recording such payments and removing the infraction from the records of the authority or agency.

It is accordingly an object of the present invention to provide a simple and reliable method and system for the electronic payment of unpaid or missed tolls which overcome the foregoing disadvantages.

It is a more specific object of the invention to provide a method and system for the electronic payment of unpaid or missed tolls utilizing a web-based system that records information relating to the unpaid or missed tolls and provides access to drivers or customers to a website whereby drivers/customers can electronically arrange for non-cash payment of unpaid or missed tolls.

It is yet another object of the invention to provide a method and system for the electronic payment of unpaid or missed tolls utilizing a web-based system that not only allows for such payments but also allows for the ability to audit various types of information relating to such payments and provides the ability to remove or delete information relating to violations when payment has been made.

It is another and more specific object of the invention to provide a method and system for monitoring the electronic payment of unpaid or missed tolls utilizing a web-based system for purposes of reducing payment processing time and operational costs and allowing the ability to generate various reports for accounting, financial, enforcement and other operational purposes.

### BRIEF SUMMARY OF THE INVENTION

The concepts of the present invention reside in a method and system for the electronic payment of unpaid or missed tolls utilizing a web-based system by which drivers/customers may arrange for payments over the internet. In accordance with the present invention, a method is provided that allows a driver or customer who fails to pay the requisite fee or toll on, for example, a toll road, to pay by locating the website of the appropriate authority or agency and then inputting information sufficient to identity the driver or customer. The number and location of occurrences of unpaid or missed tolls can be determined, either through information provided by surveillance methods or information provided by the driver or customer.

In accordance with the present invention, once the actual dollar amount of the unpaid or missed tolls is determined, the driver or customer provides the necessary information to allow for electronic payment. In a preferred practice of the invention, after such payment is confirmed, information relating to the occurrences of non-payment or missed tolls can be removed or deleted. The method of the present invention may provide a “grace period” for payment for missed tolls, allowing such payment to be made with a certain amount of time from the occurrence. If payment is made after the “grace period” has expired, the method may be further provided with the ability to assess additional amounts for violations and require payment of such additional amounts.

In addition to the method providing access to drivers or customers, it is an important concept of the invention that the method provide the ability for the appropriate authority or agency to monitor and/or audit the occurrences of unpaid or missed tolls, to accept the electronic payment of such missed tolls and to match such payments with information relating to pending or potential violations to remove or eliminate such violations. Preferably, this includes storing information provided by the surveillance methods and storing information provided by the driver or customer in at least one database. The preferred method of the present invention also provides the ability to generate financial and statistical reports for the purposes of monitoring various accounting, operational and enforcement functions associated with the electronic payment and collection of such monies.

### BRIEF DESCRIPTION OF THE DRAWINGS

The present invention is described by way of the following drawings:

FIGS. 1 through 8 are flow diagrams illustrating the method and system for providing the electronic payment of missed tolls in accordance with the present invention.

### DETAILED DESCRIPTION OF THE INVENTION

In accordance with the concepts of the present invention, there is provided a tollway, roadway or the like, which is capable of electronically monitoring traffic and payment of tolls using transponders, in vehicles, and readers, in certain stationary locations, to communicate and make automatic payment of tolls as set forth in, for example, U.S. Pat. Nos. 6,661,352 and 6,653,946, Various state and local government agencies have converted their tollways and toll bridges to “open road tolling” systems, allowing for automatic payment and reducing interruptions in the flow of traffic that occurs when vehicles are required to stop for purposes of paying tolls.

To facilitate the usage of transponders on tollways and the like, most state and local governmental authorities or agencies have established web-sites that allow customers to not only monitor information relating to such tollways but also to establish and maintain accounts for such customers. Usually, such websites provide the platforms on which additional methods and systems are incorporated, including the method and system of the present invention. In the State of Illinois, the current web-sites for the Illinois Tollway Authority is www.getipass,com and www.illinoistollway.com.

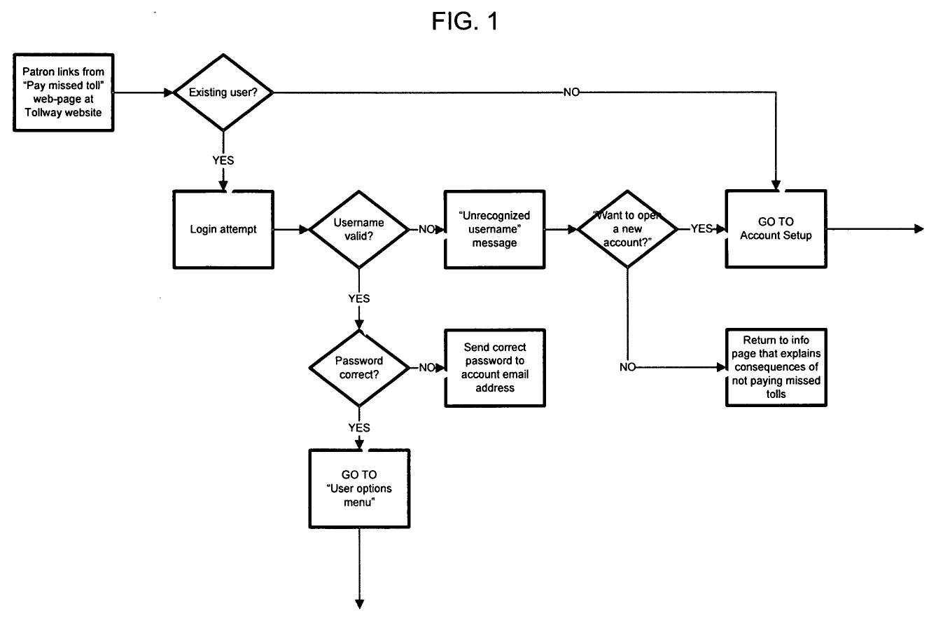

The preferred embodiment of the method of the present invention is illustrated in FIGS. 1 through 8. Beginning with FIG. 1, a customer or driver locates the website for the appropriate toll system authority or agency, via the internet, and arrives at the login or home page. On the homepage a link is provided to allow a driver, customer or patron to locate the web-page dealing payment of missed tolls. As set forth in FIG. 1, the web-page then prompts the customer to identify whether or not the customer is an existing user or customer of the toll system, that is, whether or not the customer has made missed toll payments before or if the customer is a holder of a transponder registered with the toll system or related systems.

If the customer is an existing user, he/she is prompted to login. As shown in FIG. 1, if the login, usually entry of a username and password, is successful, then the customer is directed to proceed to a “user options” or like menu. If the login is not successful, then the customer is prompted to determine whether he/she wishes to set up a new account. As shown in FIG. 1, if the answer is yes, the customer is directed to go to the web-page for account set up. If the answer is no, then the system returns the customer to the web-page explaining the consequences of the non-payment of missed tolls. As is also shown in FIG. 1, if a customer is an existing user who enters an incorrect password, the system will prompt the customer to further identify himself/herself and then provide, via e-mail, the correct password to complete the login.

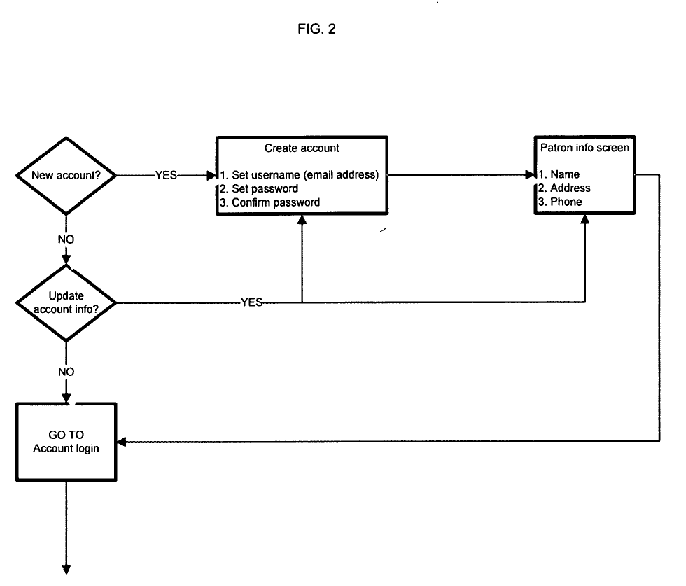

FIG. 2 provides the directions and information often necessary to provide either a secure account set-up or update of an existing account with the appropriate toll system authority or agency. As shown in FIG. 2, the new account is created by setting up some basic information, such as a username, usually an e-mail address and a password and then confirmation of the password. After that, background information may be provided, such as name and address and the like. While not shown in FIG. 2, information relating to other areas, including the type of vehicles driven or owned by the customer may also be requested. The aforementioned data, along with data subsequently entered by the customer, is stored in at least one appropriate database. Once the required information is provided, as shown in FIG. 2, the new account is then directed to go to the account login web-page, FIG. 1, to login.

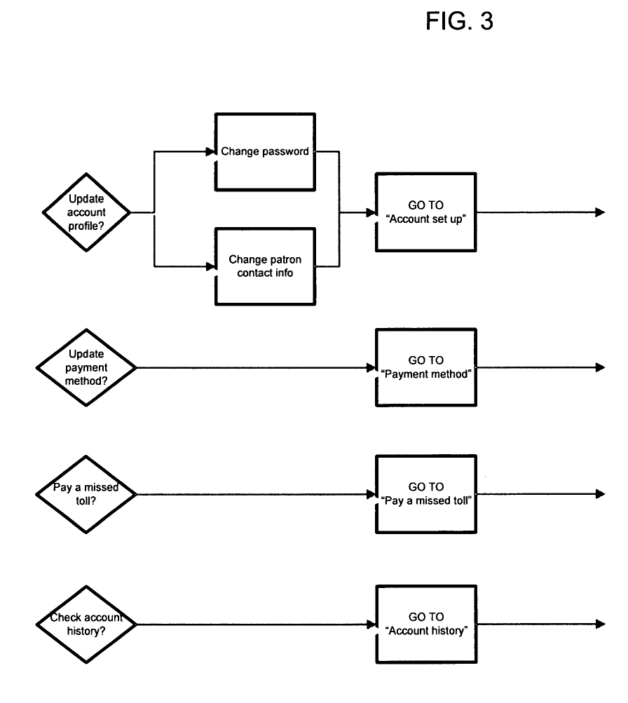

As is also shown in FIG. 2, existing customers may use the account set-up web-page to update account information. If a customer chooses to do so, the customer may update the information provided. Just as before, the data entered is stored in at least one appropriate database. After the information is updated, then, like the new customers, the existing customer returns to the account login web-page of FIG. 1 to login. Once the login is completed, the customer is then directed to FIG. 3, a web-page that would be labeled user options menu or the like.

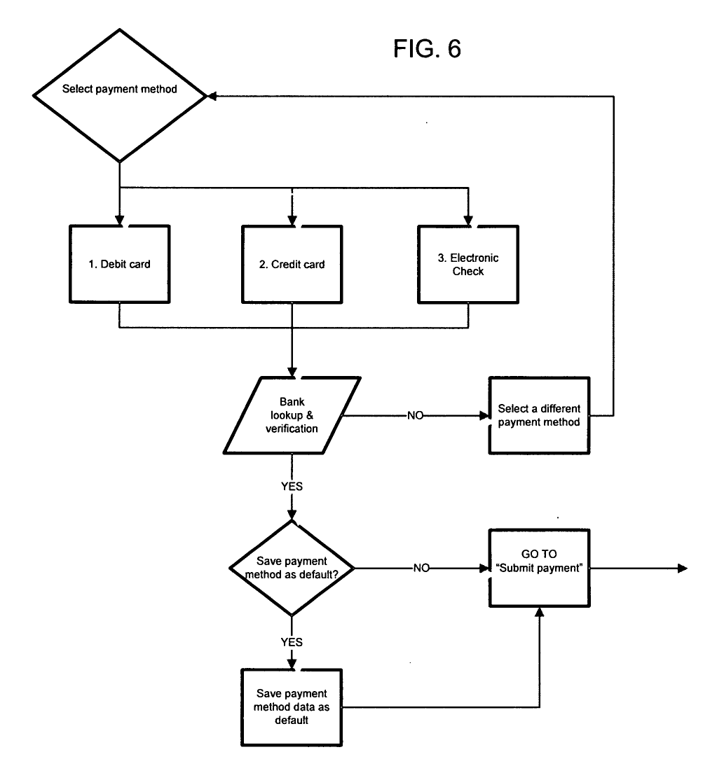

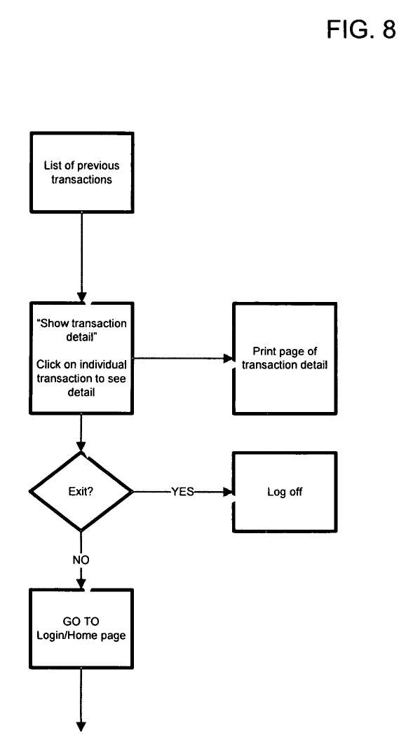

As set forth in FIG. 3, the customer is provided a number of choices which will, in turn, direct the customer to various web-pages. If the customer wishes to update the account profile, the customer is directed back to the web-pages illustrated in FIG. 2 (and then FIG. 1). If the customer wishes to update the method of payment, he/she is directed to a web-page like that illustrated in FIG. 6. And, if the customer wishes to check on his/her account history, he/she would be directed to a web-page similar to the one illustrated in FIG. 8.

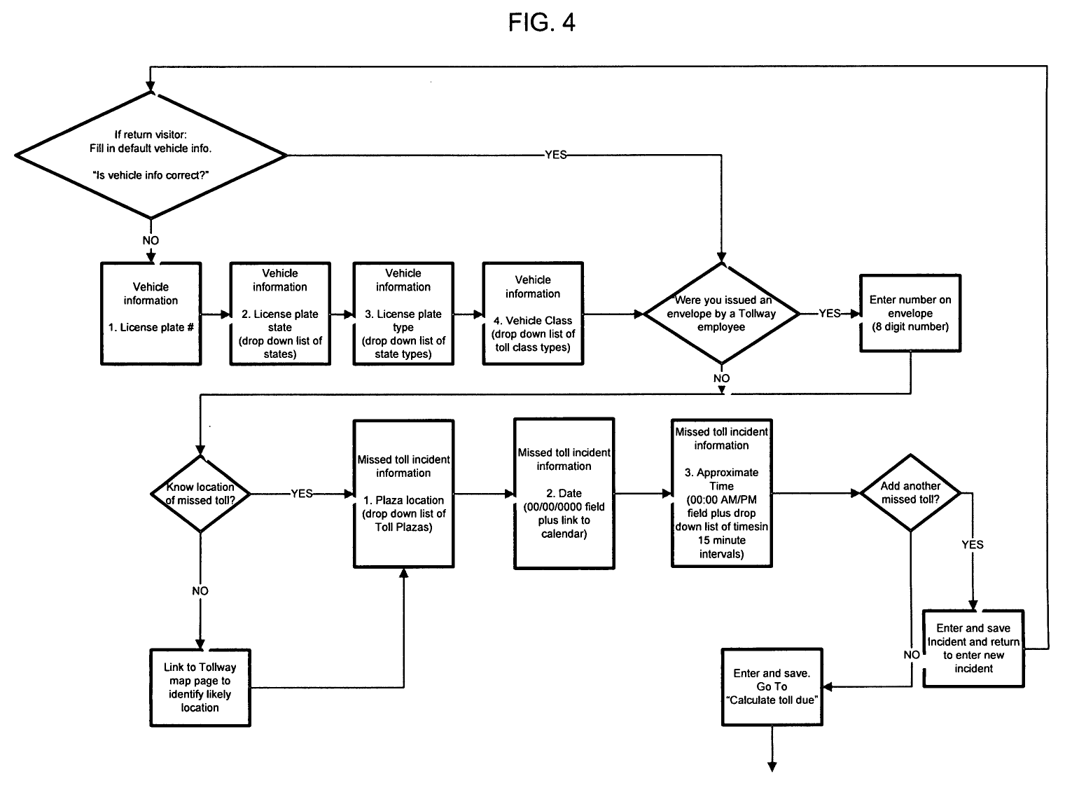

For purpose of the present invention, FIG. 3 shows the option to “pay a missed toll”. When a customer selects that option, he/she is directed to a web-page labeled “pay a missed toll” or the like. FIG. 4 illustrates the method and or system to be employed to determine the number and location of occurrences of unpaid or missed tolls. As shown in FIG. 4, information is elicited from the customer to determine whether the customer is a return visitor and if the information on the vehicle is correct. If the answer to either question is no, then the customer is prompted through one or more screens for information relating to the customer's vehicle. As shown in FIG. 4, such information includes the license plate number, state, type and vehicle class for the vehicle in question. While not shown in FIG. 4, additional information, such as make, model, year and color of the vehicle may also be requested. Such information is also stored in at least one database.

As illustrated in FIG. 4, after such information on the vehicle is provided or the return visitor indicates that the vehicle information is correct, the customer is then queried as to the receipt of an envelope from a toll system employee. While not shown in FIG. 4, additional queries relating to materials or information from the toll system or its employees may also be included. As shown in FIG. 4, if such a receipt or other information has been provided, the customer is prompted to enter identifying codes or numbers from the materials.

As further illustrated in FIG. 4, the customer then is directed through various queries, which may be presented on one or more screens, dealing with the location of the missed tolls. If the customer does not know the location of the missed toll, a link can be provided to a web-page providing a map of the toll system to identify the location. As also illustrated in FIG. 4, once the location of the missed toll is identified, then the customer is prompted to provide information on the “missed toll incident”. Such information relates to the location of the missed toll (usually identified in a drop down list of toll plazas, a map link or the like), the date of the occurrence (linked to a calendar) and the approximate time of the occurrence (usually aided by a drop down list of time in certain intervals). While not shown in FIG. 4, additional information may be requested to allow more accurate identification of the occurrence.

As illustrated in FIG. 4, once the “missed toll incident” information is entered, the customer is queried as to whether or not he/she wishes to report another missed toll. If the answer to the query is yes, the customer is directed to enter and save the reported incident and is then prompted to return to the beginning of the missed toll web-page to enter a new incident. When the answer to the query is no, then the customer is directed to enter and save and then proceed to the web-page for calculating the amount of money due for the missed toll or tolls.

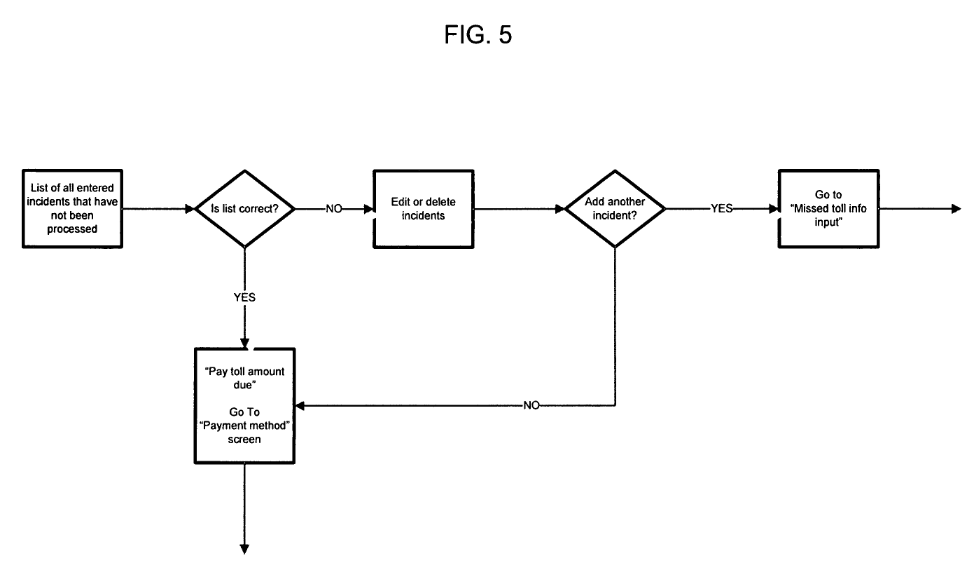

FIG. 5 illustrates the method or steps employed for calculating the amount due for the missed tolls. After the incidents have been reported as set forth in FIG. 4, the customer is requested to confirm the correctness of the list of incidents reported. If the list is not correct, the customer is prompted to either edit or delete the incidents or add other incidents by providing additional information to the missed toll input of FIG. 4. Once the customer has indicated that his/her list is complete and correct, the customer is prompted to proceed to the “payment method” screen.

FIG. 6 illustrates the options that a customer is offered for selecting an electronic method of payment of missed tolls. Such options include, at the present time, the use of a debit card, credit card or electronic check. While not shown in FIG. 6, other automatic payment options may also be employed. As further shown in FIG. 6, once the payment method is selected, the system then verifies the information provided with a financial institution or service. If the verification is not obtained, then the customer is prompted back to select a different method of payment. Once the method of payment is verified, as shown in FIG. 6, the customer is given the further option of saving his/her method of payment as his/her default. Whether or not the customer chooses to save the payment method as a default, the customer is then prompted to move onto the “submit payment” screen or web-page.

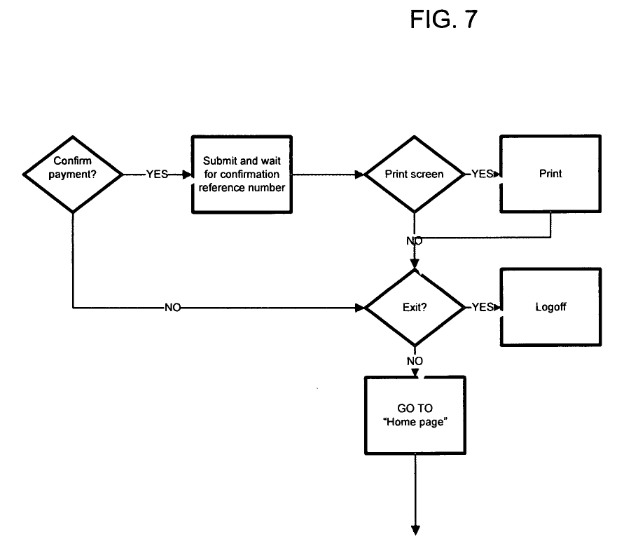

As shown in FIG. 7, the “submit payment” screen or web-page requests that the customer confirm payment of the missed tolls. If the customer responds in the affirmative, the payment is submitted by the system which provides a confirmation reference identifier, such as a number, and the ability to print the screen containing such information. As is also shown in FIG. 7, the customer may elect not to confirm payment. Once the customer has exercised his/her options on submitting payment and obtaining a receipt, the customer is prompted to exit. If the customer exits, then he/she logs off of the website. If the customer does not exit, then the system returns the customer to the “home page”.

As set forth in FIG. 3, the method and system of the present invention provides a customer the ability to check the history of his/her account. That option, illustrated in FIG. 8, allows the customer to view and obtain a list of all previous transactions which can be expanded to show that details on each and every transaction. And, as further illustrated in FIG. 8, the customer may print such transaction detail to save for his/her records. While not illustrated in FIG. 8, the customer may be provided other options to store or save his/her record or receipt. After such account information is viewed and/or printed, the customer is then prompted to exit. If the customer chooses to exit, then he/she logs off of the system. If the customer does not exit, then he/she is prompted to return to the login/home page.

In addition to providing a method and system for the electronic payment of missed tolls, the present invention also provides the toll system authority or agency with the ability to allow a customer a “grace period” for payment of missed tolls without additional penalties for violations. Such grace periods can be provided for at various steps in the process, but are usually set and calculated when the customer provides the “missed toll incident” information.

The method and system of the present invention may also be utilized in conjunction with various databases used in the toll system to collect information and generate various reports. For example, the database created by the method and system of the present invention may be used to compare and/or match up to unpaid toll and violations databases to audit and/or record payment and erase or eliminate pending or potential violations with the time period allowed by the system (i.e., the grace period). In addition, the database created by the method of the present invention also can be used to reconcile other missed transactions such as to monitor collections, payment processing, bank reconciliation, operations and enforcement procedures. In short, the present invention creates a database that can be used to provide statistical information useful to toll system authorities and agencies for both monetary and operational purposes.

The foregoing description is merely illustrative of the preferred method and system of the present invention. It will be understood that various changes and modifications can be made in the details of the method and system described above without departing from the spirit of the invention, especially as defined in the following claims.

What is claimed is:

1. A method of reconciling missed transactions comprising:
identifying and storing one or more missed transactions in at least one database;
accessing said database via the internet;
entering information relating to the one or more missed transactions into the database; and
electronically providing payment for the one or more missed transactions via the internet.

2. The method according to claim 1 wherein the identified missed transactions and the information relating to the missed transactions are each stored in a single database.

3. The method according to claim 1 wherein the identified missed transactions and the information relating to the missed transactions are stored in multiple databases.

4. The method according to claim 1 further comprising generating a receipt confirming payment of the missed transaction.

5. The method according to claim 1 wherein said missed transactions comprise unpaid tolls, outstanding monetary penalties, outstanding debts for goods, or outstanding debts for services.

6. The method according to claim 1 wherein payment of the missed transaction is provided electronically through the use of a debit card, a credit card, or an electronic check.

7. The method according to claim 1 further comprising calculating the amount due for reconciling the missed transaction.

8. The method according to claim 1 further providing editing the information entered relating to the missed transactions prior to providing payment of the missed transaction.

9. The method according to claim 1 further comprising generating one or more statistical reports based on the information stored in the at least one database.

10. The method according to claim 1 further comprising entering information related to a notice of a missed transaction into said database.

11. The method according to claim 1 further comprising
creating a user account having a login name and a password for providing a user access to information entered and stored in said database relating to missed transactions.

12. A method of reconciling missed toll transactions comprising:
identifying a missed toll transaction via electronic surveillance equipment;
storing information acquired by said electronic surveillance equipment relating to said missed toll transaction in at least one database;
accessing said at least one database via the internet;
entering and storing additional information relating to the missed toll transaction into the at least one database; and
electronically providing payment of the missed toll transaction via the internet.

13. The method according to claim 12 wherein the identified missed toll transaction and the information relating to the missed toll transaction are each stored in a single database.

14. The method according to claim 12 wherein the identified missed toll transaction and the information relating to the missed toll transaction are stored in multiple databases.

15. The method according to claim 12 further comprising generating a receipt confirming payment of the missed toll transaction.

16. The method according to claim 12 wherein payment of the missed toll transaction is provided electronically through the use of a debit card, a credit card, or an electronic check.

17. The method according to claim 12 further comprising calculating the amount due for reconciling the missed toll transaction.

18. The method according to claim 12 further providing editing the information entered relating to the missed toll transactions prior to providing payment of the missed toll transaction.

19. The method according to claim 12 further comprising generating one or more statistical reports based on the information stored in the at least one database.

20. The method according to claim 12 further comprising creating a user account having a login name and a password for providing a user access to information entered and stored in said database relating to missed toll transactions.

21. A method of reconciling missed transactions comprising:
identifying one or more missed transactions;
storing said missed transactions in at least one database;
accessing said at least one database via the internet;
entering information relating to the one or more missed transactions into the at least one database;
cross-referencing said identified missed transactions with said entered information relating to the one or more missed transactions;
calculating the amount due for reconciling the one or more missed transactions; and
electronically providing payment of the amount due for the one or more missed transactions via the internet.

22. The method according to claim 21 wherein said missed transactions comprise unpaid tolls, outstanding monetary penalties, outstanding debts for goods, or outstanding debts for services.
